(19) United States
(12) Patent Application Publication
(10) Pub. No.: US 2025/0383504 A1
(43) Pub. Date: Dec. 18, 2025

(54) POLARIZATION BEAMSPLITTERS FOR PHOTONIC INTEGRATED CIRCUITS

(71) Applicant: Apple Inc., Cupertino, CA (US)

(72) Inventors: Mutasem Odeh, Sunnyvale, CA (US); Constantin Dory, Saratoga, CA (US); Jason s Pelc, Sunnyvale, CA (US); Yu Miao, Sunnyvale, CA (US)

(21) Appl. No.: 19/239,620

(22) Filed: Jun. 16, 2025

Related U.S. Application Data
(60) Provisional application No. 63/660,999, filed on Jun. 17, 2024.

(51) Int. Cl. G02B 6/27; G02B 5/30

(52) U.S. Cl. CPC G02B 6/2773; G02B 5/3066; G02B 6/2726

(57) ABSTRACT

A photonic integrated circuit as discussed herein may include a polarization splitter that includes a set of Brewster windows. The polarization splitter includes an input waveguide, a set of output waveguides, and an intermediate waveguide optically connecting the input waveguide to the set of output waveguides. Each Brewster window is positioned to intersect a corresponding portion of the intermediate waveguide. The polarization splitter is configured to receive input light that includes one or more wavelengths within an operating wavelength range, and to use the input light to generate polarized output light at each of the set of output waveguides. Collectively, the set of Brewster windows generates a passed beam that passes through each of the Brewster windows, as well as one or more reflected beams, each of which is reflected from a corresponding Brewster window. These beams may form the polarized output light generated by the polarization splitter.

### CROSS-REFERENCE TO RELATED APPLICATIONS

This application claims the benefit under 35 U.S.C. § 119 (e) of U.S. Provisional Patent Application No. 63/660,999, filed Jun. 17, 2024, the contents of which are incorporated herein by reference as if fully disclosed herein.

### TECHNICAL FIELD

This disclosure relates generally to photonic integrated circuits that include a polarization splitter. More particularly, this disclosure relates to polarization splitters that include one or more Brewster windows intersecting a waveguide of the polarization splitter.

### BACKGROUND

Photonic integrated circuits are increasingly used in optical systems, and represent a compact and scalable option for integrating multiple optical components into a single, mass-producible unit. Photonic integrated circuits may include a variety of optical components for routing, modifying, and/or otherwise manipulating light carried by the photonic integrated circuit, and may use waveguides to route light between the different optical components. It may be desirable to understand and/or control the polarization of light being carried by a portion of a photonic integrated circuit. For example, certain photonic integrated circuits may separately control light having different polarizations to carry information, such as in polarization-division multiplexing. In other instances, a particular optical component may be designed to operate with light having a particular polarization, and as such it may be desirable to minimize light of other polarizations received by that optical component. Accordingly, it may be desirable to provide compact, on-chip polarization splitters to separate incoming light based on polarization state.

### SUMMARY

Embodiments described herein relate to photonic integrated circuits that include polarization beamsplitters. Some embodiments are directed to a photonic integrated circuit with a light source unit operable to generate input light at one or more wavelengths spanning an operating wavelength range and a polarization splitter. The polarization splitter includes an input waveguide positioned to receive the input light, a set of output waveguides, an intermediate waveguide optically connecting the input waveguide to the set of output waveguides, and a set of Brewster windows, where each Brewster window of the set of Brewster windows is positioned to intersect the intermediate waveguide. The polarization splitter is configured such that, when the input light is received at the input waveguide i) each Brewster window of the set of Brewster window receives a corresponding portion of the input light, ii) each Brewster window of the set of Brewster window is angled relative to the corresponding portion of the input light at a corresponding angle that is a Brewster angle for a corresponding target wavelength within the operating wavelength range, and iii) each output waveguide of the set of output waveguides outputs a corresponding polarized light output having a corresponding polarization.

In some variations, the set of Brewster windows is configured to generate, from the input light, a set of reflected beams and a passed beam. Each reflected beam of the set of reflected beams is reflected from a corresponding Brewster window and the passed beam passes through each Brewster window of the set of Brewster windows. In some of these variations, the set of output waveguides includes a first output waveguide and the passed beam is directed to the first output waveguide to output a first polarized light output having a first polarization. Additionally or alternatively, the set of output waveguides includes a second output waveguide and a first reflected beam of the set of reflected beams is directed to the second output waveguide to output a second polarized light output having a second polarization.

The set of Brewster windows may include a single Brewster or a plurality of Brewster windows. In variations where the set of Brewster windows includes a plurality of Brewster windows, the set of reflected beams includes a plurality of reflected beams. In some of these variations, the set of Brewster windows includes a first subset of Brewster windows and a second subset of Brewster windows. Each Brewster window of the first subset of Brewster windows is angled in a first rotational direction relative to the corresponding portion of the input light, and each Brewster window of the second subset of Brewster windows is angled in an opposite second rotational direction relative to the corresponding portion of the input light.

Other embodiments are directed to a photonic integrated circuit that includes a polarization splitter configured to receive input light at one or more wavelengths within an operating wavelength range. The polarization splitter includes an input waveguide positioned to receive the input light, a set of output waveguides a slab waveguide optically connecting the input waveguide to the set of output waveguides, and a set of Brewster windows. Each Brewster window of the set of Brewster windows is positioned to intersect the slab waveguide, and the set of Brewster windows is configured to generate, from the input light, a set of reflected beams and a passed beam. The passed beam passes through each Brewster window of the set of Brewster windows, and each reflected beam of the set of reflected beams is reflected from a corresponding Brewster window.

In some variations, the polarization splitter includes a first set of reflectors positioned in the slab waveguide and configured to collimate the input light. In some variations, the set of output waveguides includes a first output waveguide and the passed beam is directed to the first output waveguide to output a first polarized light output having a first polarization. In some of these variations, the polarization splitter includes a second set of reflectors positioned in the slab waveguide and configured to focus the passed beam on the first output waveguide. Additionally or alternatively, the set of output waveguides includes a second output waveguide and a first reflected beam of the set of reflected beams is directed to the second output waveguide to output a second polarized light output having a second polarization. In some of these variations, the polarization splitter includes a third set of reflectors positioned in the slab waveguide and configured to focus the first reflected beam on the second output waveguide. The set of Brewster windows may include a single Brewster or a plurality of Brewster windows. In variations where the set of Brewster windows includes a plurality of Brewster windows, the set of Brewster windows includes a first subset of Brewster windows and second subset of Brewster windows. Each Brewster window of the first subset of Brewster windows is angled in a first rotational direction relative to a corresponding portion of the input light, and each Brewster window of the second subset of Brewster windows is angled in an opposite second rotational direction relative to a corresponding portion of the input light.

Still other variations are directed to a photonic integrated circuit that includes a polarization splitter configured to receive input light at one or more wavelengths within an operating wavelength range. The polarization splitter includes an input waveguide positioned to receive the input light, an output waveguide, an intermediate waveguide optically connecting the input waveguide to the output waveguide, and a set of Brewster windows. Each Brewster window of the set of Brewster windows is positioned to intersect the intermediate waveguide at a corresponding angle that is a Brewster angle for a corresponding target wavelength within the operating wavelength range. The output waveguide outputs a polarized light output having a first polarization when the input waveguide receives the input light.

In some variations, the intermediate waveguide is a rib waveguide. In other variations, the intermediate waveguide is a strip waveguide. The polarization splitter may include a first waveguide taper connecting the input waveguide to the intermediate waveguide. Additionally or alternatively, the polarization splitter includes a second waveguide taper connecting the intermediate waveguide to the output waveguide. In some variations, the input waveguide and the output waveguide are positioned on a common side of the set of Brewster windows and the first polarization is a TM mode. In other variations, the input waveguide and the output waveguide are positioned on a opposite sides of the set of Brewster windows and the first polarization is a TE mode.

In addition to the example aspects and embodiments described herein, further aspects and embodiments will become apparent by reference to the drawings and by study of the following description.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 shows a schematic diagram of a photonic integrated circuit that includes a polarization splitter as described herein.

FIG. 2A depicts a top view of a portion of a photonic integrated circuit that includes a polarization splitter as described herein. FIG. 2B depicts a cross-sectional side view of a portion of the photonic integrated circuit of FIG. 2A.

FIG. 3 depicts a top view of a portion of a photonic integrated circuit that includes a variation of a polarization splitter as described herein.

FIG. 4A depicts a top view of a portion of a photonic integrated circuit that includes another variation of a polarization splitter as described herein. FIG. 4B depicts a cross-sectional side view of a portion of the photonic integrated circuit of FIG. 4A.

FIG. 5 depicts a top view of a portion of a photonic integrated that includes still another variation of a polarization splitter, such as described herein, that has a single output waveguide.

FIG. 6 depicts a schematic diagram of a wavelength locking unit that incorporates a polarization splitter as described herein.

It should be understood that the proportions and dimensions (either relative or absolute) of the various features and elements (and collections and subsettings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

Directional terminology, such as “top”, “bottom”, “upper”, “lower”, “front”, “back”, “over”, “under”, “above”, “below”, “left”, “right”, “vertical”, “horizontal”, etc. is used with reference to the orientation of some of the components in some of the figures described below, and is not intended to be limiting. Because components in various embodiments can be positioned in a number of different orientations, directional terminology is used for purposes of illustration to demonstrate the relative orientation between components of the systems and devices described herein. The directional terminology is intended to be construed broadly, and therefore should not be interpreted to preclude components being oriented in different ways. Also, as used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to photonic integrated circuits that include a polarization splitter that includes a set of Brewster windows. The polarization splitter includes an input waveguide, a set of output waveguides, and an intermediate waveguide optically connecting the input waveguide to the set of output waveguides. Each Brewster window is positioned to intersect a corresponding portion of the intermediate waveguide. The polarization splitter is configured to receive input light that includes one or more wavelengths within an operating wavelength range, and to use the input light to generate polarized output light at each of the set of output waveguides. Each Brewster window is positioned to receive a corresponding portion of the input light, and is angled relative to the corresponding portion of the input light at a corresponding angle that is the Brewster angle for a corresponding target wavelength in the operating wavelength range. Collectively, the set of Brewster windows generates a passed beam that passes through each of the Brewster windows, as well as one or more reflected beams, each of which is reflected from a corresponding Brewster window. The passed beam and/or a reflected beam may be passed to corresponding output waveguides to generate the polarized output light.

In some instances, it may be desirable for a photonic integrated circuit, as well as any optical systems incorporating a photonic integrated circuit, to be able to operate over a wide range of wavelengths. Depending on the intended use of a given optical system (e.g., performing spectroscopic measurements, optical signal transmission or processing, or the like), a light source unit as described herein may be operable to generate light at multiple wavelengths spanning hundreds of nanometers, and the polarization splitters that receive this light may be designed to accommodate wavelengths spanning some or all of this range. In these instances, it is desirable for a given optical component to have a similar level of performance regardless of the wavelength of light it receives.

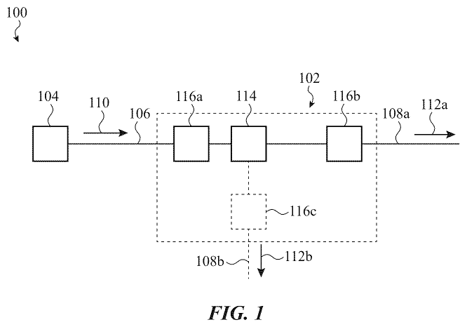

These foregoing and other embodiments are discussed below with reference to FIGS. 1-6. However, those skilled in the art will readily appreciate that the detailed description given herein with respect to these figures is for explanation only and should not be construed as limiting.

FIG. 1 shows a schematic diagram of a photonic integrated circuit 100 as described herein. Specifically, the photonic integrated circuit 100 may be configured to generate or receive light, and a polarization splitter 102 that is configured to split the light based on its polarization. For example, the photonic integrated circuit 100 includes a light source unit 104 that has one or more light sources and is operable to generate light. The light source unit 104 is optically connected to the polarization splitter 102, such that light generated by the light source unit 104 is received by the polarization splitter 102. It should be appreciated that, depending on the configuration of the photonic integrated circuit 100, light generated by the light source unit 104 may pass through and/or interact with a range of additional optical components (e.g., multiplexers, splitters, phase shifters, filters, amplifiers, modulators or the like) before reaching the polarization splitter 102.

The polarization splitter 102 includes an input waveguide 106 and a set of output waveguides 108a-108b that includes at least a first output waveguide 108a. When light (also referred to as “input light 110”, which is represented by an arrow in FIG. 1) is received by the input waveguide 106 of the polarization splitter 102, the polarization splitter 102 is configured to generate a polarized light output at each of the set of output waveguides 108a-108b. In some variations, the polarization splitter 102 includes two output waveguides (e.g., the first output waveguide 108a and a second output waveguide 108b), where the output waveguides output polarized light having orthogonal polarizations. For example, the first output waveguide 108a may output light that is at least partially polarized with a TE (transverse electric) mode (also referred to herein as “first polarized output light 112a”, which is represented by an arrow in FIG. 1) and the second output waveguide 108b may output light that is at least partially polarized with a TM (transverse magnetic) mode (also referred to herein as “second polarized output light 112b”, which is represented by an arrow in FIG. 1). In other variations, the polarization splitter 102 may have a single output waveguide (e.g., the first output waveguide 108a), in which case the polarization splitter 102 may act as a filter to remove one polarization of light (though it should be appreciated that it is still called a “polarization splitter” herein for ease of discussion, even when there is a single output waveguide). In these instances, the polarization splitter 102 may output only the first polarized output light 112a, which may have either a TE mode or a TM mode depending on the configuration of the polarization splitter 102.

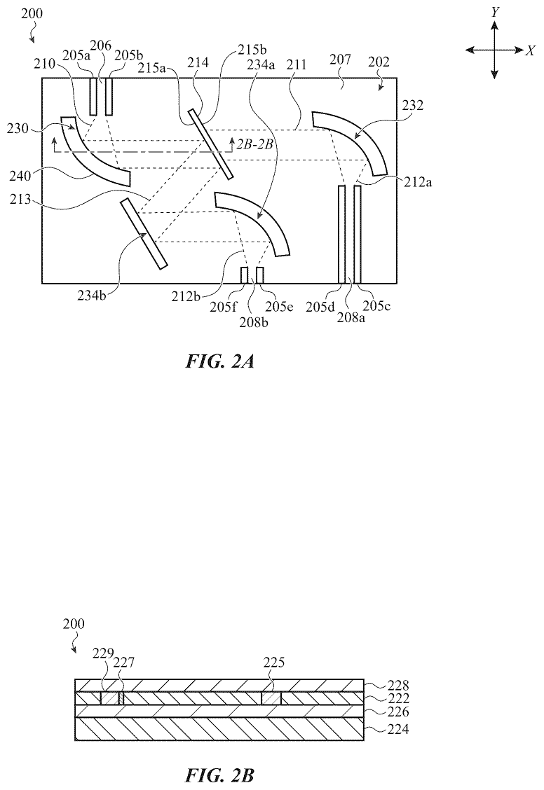

To separate the input light 110, the polarization splitter 102 includes a set of Brewster windows 114, where each Brewster window is positioned to intersect a corresponding portion of a waveguide of the polarization splitter 102. Each Brewster window is positioned such that at least a portion of the input light 110 (e.g., the initial input light or an amount of the input light 110 that has already passed through another Brewster window) is incident on a surface of the Brewster window. The Brewster window may act to selectively direct light based on its polarization, such that each of the set of output waveguides 108a-108b receives light that is at least partially polarized with a corresponding polarization. Examples of polarization splitters 102 that include a set of Brewster windows 114 are described herein with respect to FIGS. 2A-5.

The polarization splitter 102 may, during operation of the photonic integrated circuit 100, receive a single wavelength or light or may receive a plurality of different wavelengths of light. Accordingly, the polarization splitter 102 may be configured to operate across a range of different wavelengths (referred to herein as an “operating wavelength range”). When the photonic integrated circuit 100 is configured such that the polarization splitter 102 receives light from the light source unit 104 at a plurality of different wavelengths, the plurality of different wavelengths spans an operating wavelength range that includes a maximum wavelength of the operating wavelength range and a minimum wavelength range of the operating wavelength range. In other words, the light source unit 104 includes at least one light source configured to emit light at the minimum wavelength and at least one light source configured to emit light at the maximum wavelength.

To the extent that the light source unit 104 includes multiple light sources, the photonic integrated circuit 100 may include one or more multiplexers (not shown) that are configured to combine light generated by the light source unit 104 into a single waveguide, such that the light may be received by the input waveguide 106 of the polarization splitter 102. For example, the light source unit 104 shown in FIG. 1 includes a first light source operable to generate light at a first wavelength 21 that is the shortest (e.g., minimum) wavelength that may be routed to the polarization splitter 102 during operation of the photonic integrated circuit 100. Similarly, the light source unit 104 may include a second light source operable to generate light at a second wavelength λ_{N} that is the longest (e.g., maximum) wavelength that may be routed to the input waveguide 106 during operation of the photonic integrated circuit 100. The first and second light sources define the boundaries of the operating wavelength range for the input waveguide 106. The light source unit 104 may include one or more additional light sources that are operable to emit light at one or more wavelengths within the operating wavelength range.

The number and, in the instances of multiple different wavelengths, range of wavelengths that may be received by the polarization splitter 102 may depend on the operating requirements of the photonic integrated circuit 100, as well as the intended operation of the polarization splitter 102 within the photonic integrated circuit 100. In some instances the polarization splitter 102 may receive light at wavelengths across a relatively wide operating wavelength range. For example, in some variations the operating wavelength range spans at least 300 nanometers (i.e., the difference in wavelength between the maximum wavelength and the minimum wavelength is at least 300 nanometers). In some of these variations, the operating wavelength range spans at least 600 nanometers (i.e., the difference in wavelength between the maximum wavelength and the minimum wavelength is at least 600 nanometers). In some of these variations, the operating wavelength range spans at least 900 nanometers (i.e., the difference in wavelength between the maximum wavelength and the minimum wavelength is at least 900 nanometers).

Accordingly, it may be desirable for the polarization splitter 102 to maintain a certain level of performance across its operating wavelength range. That said, it should be appreciated that there may be some differences in performance at different wavelengths across the operating wavelength range. For example, while it may be desirable for each output waveguide (e.g., the first output waveguide 108a and the second output waveguide 108b) to output light having only a single polarization, it should be appreciated that, for input light at some or all of the wavelengths across the operating wavelength range, at least one of the output waveguides 108a-108b may output light that is partially polarized (e.g., includes a combination of TE and TM modes). Accordingly, when the output waveguide of a polarization splitter is described herein as outputting “polarized output light” having a particular polarization, it should be understood that the polarization splitter acts to increase the degree of polarization of that polarization as compared to the input light. In this way, the polarization splitter decreases the relative percentage of an orthogonal polarization, as compared to the input light, for a given polarized light output.

For example, if the polarization splitter 102 generates polarized output light (e.g., the first polarized output light 112a) having a TE mode at an output waveguide (e.g., the first output waveguide 108a), the polarized output light will have a first percentage of the TE mode of the input light 110 and a second percentage of the TM mode of the input light 110, where the second percentage is lower than the first percentage. Conversely, if the polarization splitter generates polarized output light (e.g., the second polarized output light 112b) having a TM mode at an output waveguide (e.g., the second output waveguide 108b), the polarized output light will have a first percentage of the TE mode of the input light 110 and a second percentage of the TM mode of the input light 110, where the second percentage is higher than the first percentage. Accordingly, if the input light 110 is unpolarized (e.g., has equal amounts of light with TE and TM modes), a polarized output light having a TE mode will have a larger amount of TE mode than TM mode and a polarized output light having a TM mode will have a larger amount of TM mode than TE mode. The degree of polarization that occurs for each polarized output light of the polarization splitter 102 depends on the design of the polarization splitter 102, as well as the wavelength that is currently being received by the polarization splitter 102.

It should be appreciated that, depending on the operation of the photonic integrated circuit 100, the polarization splitter 102 may receive a plurality of wavelengths across the operating wavelength range, but may not receive all of the plurality of wavelengths simultaneously. Accordingly, when a light source unit (such as light source unit 104) is described herein as being operable to generate light at a plurality of different wavelengths (e.g., that span the operating wavelength range), the light source unit 104 need not be operated to simultaneously generate (or in some instances, even be capable of simultaneously generating) all of these wavelengths. The light source unit 104 may simultaneously generate the plurality of different wavelengths or may generate different wavelengths (or groups of wavelengths) at different times. When a polarization splitter (such as polarization splitter 102) is discussed herein as receiving a plurality of different wavelengths (e.g., that spans the operating the wavelength range), it should be appreciated that the polarization splitter 102 may similarly receive these wavelengths simultaneously or at different times (e.g., during different operating modes of the photonic integrated circuit 100). Additionally, the light source unit need not be able to generate the entire spectrum within the operating wavelength range (e.g., every wavelength between the longest and shortest wavelength of the operating range), and in some instances may only generate a discrete number of wavelengths within the operating wavelength range.

Each light source of the light source unit 104 is selectively operable to emit light at a corresponding set of wavelengths. Each light source may be any component capable of generating light at one or more particular wavelengths, such as a laser. A laser may include a semiconductor laser, such as a laser diode (e.g., a distributed Bragg reflector laser, a distributed feedback laser, an external cavity laser), a quantum cascade laser, or the like. A given light source may be single-frequency (fixed wavelength) or may be tunable to selectively generate one of multiple wavelengths (e.g., the light source may be controlled to output different wavelengths at different times). The set of light sources may include any suitable combination of light sources, and collectively may be operated to generate light at any of a plurality of different wavelengths. Accordingly, input light 110 received by the polarization splitter 102 (e.g., via the input waveguide 106) may include, at a given time, any wavelength or combination of wavelengths in the operating range of wavelengths depending on the photonic integrated circuit 100.

In some variations, the polarization splitters described herein may include one or more higher order mode filters (also referred to herein as “HOM filters”) that are configured to selectively remove higher order modes. For example, in some variations it may be desirable for the polarization splitter 102 to both receive and output light having a fundamental mode. Accordingly, it may be desirable to remove light at higher order modes that are either part of the input light 110 or otherwise generated within the polarization splitter 102. For example, as shown in FIG. 1, the polarization splitter 102 includes a set of HOM filters 116a-116c. The polarization splitter 102 may include a first HOM filter 116a that is positioned to selectively remove higher order modes from the input light 110 in the input waveguide 106 (e.g., before the input light 110 is incident on the set of Brewster windows 114. Additionally or alternatively, the polarization splitter 102 may include a second HOM filter 116b that is positioned to selectively remove higher order modes from the first polarized output light 112a in the first output waveguide 108a. In variations in which the polarization splitter 102 includes a second output waveguide 108b, the polarization splitter 102 may include a third HOM filter 116c that is positioned to selectively remove higher order modes from the second polarized output light 112b in the second output waveguide 108b.

The polarization splitters described herein may be formed as part of a planar waveguide layer of a photonic integrated circuit. The polarization splitter may include an intermediate waveguide optically connecting the input waveguide to the set of output waveguides, and the set of Brewster windows may be positioned to intersect corresponding portions of the intermediate waveguide. In some variations, the polarization splitter may be configured such that the intermediate waveguide is a slab waveguide. For example, FIG. 2A shows a top view of a portion of a photonic integrated circuit 200 that includes a variation of polarization splitter 202 as described herein. FIG. 2B shows a cross-sectional side view of a portion of the photonic integrated circuit 200, taken along line 2B-2B.

The photonic integrated circuit 200 may include a planar waveguide layer 222 that is supported by a substrate 224. In some instances a first cladding layer 226 is positioned between the substrate 224 and the waveguide layer 222, such that the substrate supports the first cladding layer 226, and the first cladding layer 226 supports the waveguide layer 222. The first cladding layer 222 may help to confine light within a plane of the waveguide layer 222, and the photonic integrated circuit 200 may include additional cladding layers positioned in contact with other surfaces of the waveguide layer 222. For example, the photonic integrated circuit 200 may include a second cladding layer 228 (not shown in FIG. 2A), such that at least a portion of the waveguide layer 222 is positioned between the first cladding layer 226 and the second cladding layer 228. The various layers of the photonic integrated circuits described herein may be formed from any suitable materials depending on the wavelength or wavelengths of light that will be carried by the waveguides defined in the photonic integrated circuit. For example, in some variations, the waveguide layer 222 (including any waveguides defined in and formed by the waveguide layer) is formed from silicon, silicon nitride, silica, or the like, each cladding layer (e.g., the first cladding layer 226 or the second cladding layer 228) is formed from a corresponding cladding material that may be a dielectric material (or materials) such as silicon dioxide, and the substrate 224 is formed from silicon.

The polarization splitter 202 includes an input waveguide 206, a set of output waveguides 208a-208b, and a slab waveguide 207 that acts an intermediate waveguide to optically connect the input waveguide 206 to the set of output waveguides 208a-208b. The set of output waveguides 208a-208b is shown in FIG. 2A as including two output waveguides, specifically a first output waveguide 208a and a second output waveguide 208b. It should be appreciated, however, that other variations of the polarization splitter 202 may have a single output waveguide (e.g., either the first output waveguide 208a or the second output waveguide 208b).

The waveguide layer 222 may be processed to define each of the input waveguide 206, the set of output waveguides 208a-208b, and the slab waveguide 207. Specifically, the waveguide layer 222 may be etched or patterned to define a plurality of cavities 205a-205f in the waveguide layer 222, such that these cavities 205a-205f define the input waveguide 206 and each of the set of output waveguides 208a-208b. For example, a first pair of cavities 205a-205b define the input waveguide 206 (e.g., a first cavity 205a defines a first lateral surface of the input waveguide 206 and a second cavity 205b defines a second lateral surface of the input waveguide 206). Similarly a second pair of cavities 205c-205d may define the first output waveguide 208a (e.g., a third cavity 205c defines a first lateral surface of the first output waveguide 208a and a fourth cavity 205d defines a second lateral surface of the first output waveguide 208a) and a third pair of cavities 205e-205f may define the second output waveguide 208b (e.g., a fifth cavity 205e defines a first lateral surface of the second output waveguide 208b and a sixth cavity 205f defines a second lateral surface of the second output waveguide 208b). In some instances, the plurality of cavities 205a-205f may be filled with a cladding layer (e.g., a portion of the second cladding layer 228, or a separate cladding layer from the second cladding layer 228). In other instances, such as variations in which the photonic integrated circuit 200 (or a portion thereof) does not include the second cladding layer 228, some or all cavities 205a-205f may be left unfilled to provide an air interface to the corresponding lateral side surfaces of the input waveguide 206 and the set of output waveguides 208a-208b.

Accordingly, when input light 210 is introduced into the input waveguide 206, the light may be confined within the input waveguide 206 due to a refractive index difference between the input waveguide 206 and its surrounding materials (e.g., the cladding layer(s) and/or air in contact with the waveguide 220). The first pair of cavities 205a-205b terminate at an interface between the input waveguide 206 and the slab waveguide 207. Because the first pair of cavities 205a-205b is no longer acting to laterally confine light in the input waveguide 206, input light 210 passing from the input waveguide 220 into the slab waveguide 207 may diffract and freely propagate within the slab waveguide 207. In this way, the slab waveguide 207 acts a free propagation region. It should be appreciated that while light may freely propagate laterally within the plane of the waveguide layer 222 as it travels through the slab waveguide 207, the light may still be confined vertically such that it is confined within the plane of the waveguide layer 222.

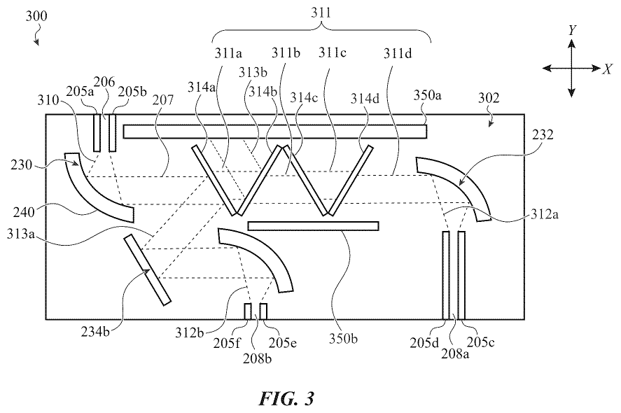

The polarization splitter 202 includes a set of Brewster windows that is positioned to intersect the slab waveguide 207, such that each Brewster window is positioned to receive a corresponding a portion of the input light 210. The set of Brewster windows is configured to generate one or more reflected beams and a passed beam, as described in more detail herein. In the example of the polarization splitter shown in FIG. 2A, the set of Brewster windows includes a single Brewster window 214. It should be appreciated that the set of Brewster windows may include a plurality of Brewster windows, such as described herein with respect to the polarization splitter 302 of FIG. 3. Each Brewster window may have a different refractive index than the slab waveguide 207 and may split a corresponding portion of the input light into two separate light beams.

Each Brewster window has a corresponding input side and an output side, where the input side and output side are parallel surfaces of the Brewster window. For example, in the variation shown in FIG. 2, the Brewster window 214 has an input side 215a and an output side 215b. The Brewster window 214 is positioned such that the input light 210 is incident on the input side 215a of the Brewster window 214. When the input light 210 is incident on the Brewster window 214, a portion of the input light 210 is reflected by the Brewster window 214 and a portion of the input light 210 is passed through Brewster window 214 and exits from the output side 215b. The passed portion of the input light 210 is referred to herein as “passed beam 211” and the reflected portion of the input light 210 is referred to herein as “reflected beam 213.” The passed beam 211 and the reflected beam 213 are each partially polarized relative to the input light 210.

Specifically, the Brewster window 214 is angled relative to the input light 210 at an angle that is the Brewster's angle for a target wavelength within the operating wavelength range. The Brewster's angle refers to an angle at which light with a first polarization, when incident on a boundary between materials having different refractive indices, passes through the boundary without reflection. When unpolarized or partially polarized light is incident on the boundary, any reflected light will be fully polarized with a second polarization orthogonal to the first polarization. Accordingly, when the input light 210 of a given wavelength is incident on the Brewster window 214 at the Brewster's angle for that wavelength, the Brewster window 214 will pass light having a first polarization (e.g., TE mode) and will partially reflect light having an orthogonal second polarization (e.g., the TM mode). Accordingly, the reflected beam 213 will theoretically include only the second polarization, and thus will be polarized with the second polarization. The passed beam 211 will include light of the first polarization, as well as light of the second polarization that was not reflected as part of the reflected beam 213. Accordingly, the passed beam 211 will be partially polarized with the first polarization.

In the polarization splitter 202 of FIGS. 2A and 2B, the passed beam 211 is coupled into the first output waveguide 208a and forms a first polarized output light 212a generated by the polarization splitter 202. Similarly, the reflected beam 213 is coupled into the second output waveguide 208b and forms a second polarized output light 212b generated by the polarization splitter 202. The first polarized output light 212a will have a reduced proportion of the second polarization (e.g., TM mode) as compared to the input light 210 whereas the second polarized output light 212b will have a reduced proportion of the first polarization (e.g., the TE mode) as compared to the input light 210. The Brewster's angle for a given interface is wavelength dependent, and thus it should be appreciated that while the Brewster window 214 may be positioned at the Brewster's angle for a target wavelength in the operating wavelength range, it may deviate from the Brewster's angle for other wavelengths in the operating wavelength range. Accordingly, depending on the wavelength (or wavelengths) included in the input light 210 at a given moment in time, the reflected beam 213 may also include an amount of the first polarization (e.g., the TE mode) that is also reflected by the Brewster window 214, and thus the second polarized output light 212b may be only partially polarized with the second polarization (e.g. the TM mode).

The target wavelength, and thereby the first angle at which the Brewster window 214 is rotated relative to the input light 210, may be selected to balance performance of the polarization splitter 202 across the operating wavelength range as may be desired. In some instances the target wavelength may correspond to a wavelength of light that is generated by a light source unit (e.g., the light source unit 104 of FIG. 1) used to generate the input light 210, such that the polarization splitter 202 may receive the target wavelength during operation of the photonic integrated circuit 200. In other instances, the target wavelength need not correspond to any of the wavelengths that are generated by the light source unit, but may instead be any wavelength that is at least as long as the shortest wavelength of the operating wavelength range and at least as short as the longest wavelength of the operating wavelength range. Accordingly, the polarization splitter 202 is designed to perform in a certain manner with respect to the target wavelength regardless of whether the light source unit is capable of generating light at the target wavelength.

The Brewster window 214 (as well as any of the other Brewster windows described herein) may be formed in any suitable manner. Specifically, whereas the waveguide layer 222 is formed from a material having a first refractive index, the Brewster window 214 is formed from a material 225 having a second refractive index that is different than the first refractive index. In some variations, the material 225 forming Brewster window 214 may be a doped region of the waveguide layer 222, such that the doped region of the waveguide layer 222 has a different refractive index than the surrounding portions of the waveguide layer 222 (e.g., the slab waveguide 207 in FIG. 2A). In other variations, the waveguide layer 222 may be etched or patterned to define a cavity in the waveguide layer 222, and the material 225 may be deposited in the cavity to form the Brewster window 214. In some of these variations, the material 225 may be the same cladding material as the first cladding layer 226 and/or second cladding layer 228. In some of these variations, a portion of the second cladding layer 228 may be positioned within cavity to form the Brewster window 214 (e.g., the cladding material of the second cladding layer 228 is the material 225). For example, in some variations where the waveguide layer 222 is formed from silicon and the first cladding layer 226 and/or the second cladding layer 228 are formed from silicon dioxide, the material 225 forming the Brewster window may be silicon dioxide.

It may be desirable for the input light 210 to approximate a plane wave when it is incident on the input side 215a of the Brewster window 214. Accordingly, in some variations the polarization splitter 202 may include one or more curved reflectors that are configured to change the divergence of light traveling through the slab waveguide 207. For example, the polarization splitter 202 may include a first set of reflectors that is positioned and configured to collimate the input light 210 before it reaches the set of Brewster windows. In the variation shown in FIG. 2A, the first set of reflectors includes a curved reflector 230 (also referred to herein as “first curved reflector 230”) that is positioned to at least partially collimate the input light 210. Accordingly, while the input light 210 may diverge after exiting the input waveguide until it reaches the first curved reflector 230. As the input light 210 reflects from the first curved reflector 230, the first curved reflector 230 may at least partially collimate the input light 210. Additionally, the first curved reflector 230 may act to redirect the input light 210. In some of these variations, the first curved reflector 230 redirects the input light 210 in a direction toward the Brewster window 214. In other variations, the first set of reflectors may include one or more additional reflectors that further redirect the right before it reaches the Brewster window 214. In some variations, one or more additional reflectors of the first set of reflectors are also curved, such that they at least partially collimate the input light 210. In this way, multiple curved reflectors of the first set of reflectors may collectively collimate the input light 210 before it reaches the Brewster window 214.

Similarly, the polarization splitter 202 may include additional reflectors that are configured to guide light into the set of output waveguides 208a-208b. In some variations, the polarization splitter 202 may include a second set of reflectors that is configured to focus the passed beam 211 on the first output waveguide 208a. For example, the second set of reflectors may include a curved reflector 232 (also referred to herein as “second curved reflector 232”) that redirects and focuses the passed beam 211 at an interface between the slab waveguide 207 and the first output waveguide 208a. By focusing the light at the interface between the slab waveguide 207 and the first output waveguide 208a, the polarization splitter 202 may reduce coupling losses as light enters the first output waveguide 208a. Similarly, the polarization splitter 202 may include a third set of reflectors that is configured to focus the reflected beam 213 on the second output waveguide 208b. For example, the second set of reflectors may include a first reflector 234a (also referred to herein as “third curved reflector 234”) that is curved to redirect and focuses the reflected beam 213 toward an interface between the slab waveguide 207 and the second output waveguide 208b. The second set of reflectors is shown as also including a second reflector 234b (also referred to herein as “first flat reflector 234b”) that is flat and configured to redirect the reflected beam 213 from the Brewster window 214 toward the third curved reflector 234. It should be appreciated that each of the second and third sets of reflectors may include any combination of flat and curved reflectors as may be desired to route and focus light to the respective output waveguide.

To form a reflector as described herein, a waveguide layer defining the slab waveguide 207 may be etched or otherwise patterned to form a cavity and expose a side surface of the slab waveguide (e.g., that is generally perpendicular to the plane of the waveguide layer within manufacturing tolerances). An interface material may be positioned in contact with the side surface of the slab waveguide 207, such that the interface between the slab waveguide 207 and the interface material acts to reflect light that is incident on the side surface of the slab waveguide 207. Accordingly, a side surface of the slab waveguide 207 may define the reflector. In some variations, the interface material may be a metal. In other variations, the interface material may be a cladding material, such as the cladding material that forms the first cladding layer 226 and/or the second cladding layer 228. It should also be appreciated that one or more additional materials may be positioned within the cavity, such that the interface material need not file the entire cavity.

Using the first curved reflector 230 as an example, the waveguide layer 222 may be patterned to define a cavity 240 extending through waveguide layer 222 to define a first side surface of the slab waveguide 207. An interface material 227 is positioned in contact with the side surface of the slab waveguide 207 to define the first curved reflector 230. Additionally, as shown in FIG. 2B, an additional material 229 may be positioned to fill the portions of the cavity 240 not otherwise filled by the interface material 227. For example, in some variations the interface material 229 may be a metal layer deposited on the side surface of the slab waveguide 207, and the additional material 229 may the same cladding material as the first cladding layer 226 and/or the second cladding layer 228. In some of these variations, the additional material 229 may be a corresponding portion of the second cladding layer 228 that extends into the cavity 240.

When light passes through a Brewster window, such as Brewster window 214, the passed light will include light of the first polarization, but may also retain a percentage of the orthogonal second polarization (e.g., the amount that is not reflected by the Brewster window 214). Accordingly, the polarized output light that is generated using this passed light may be only partially polarized with the first polarization. In some variations, it may be desirable for the input light to pass through multiple Brewster windows, which may improve the degree of polarization of the light that is passed through the set of Brewster windows.

For example, FIG. 3 shows a top view of a portion of a photonic integrated circuit 300 that includes a variation of polarization splitter 302 as described herein. The photonic integrated circuit 300 and polarization splitter 302 may be configured and labeled the same as the photonic integrated circuit 200 and polarization splitter 202 of FIGS. 2A and 2B, except that the polarization splitter 302 include a set of Brewster windows 314a-314d that includes multiple Brewster windows. While the set of Brewster windows 314a-314d is shown in FIG. 3 as including four Brewster windows (e.g., a first Brewster window 314a, a second Brewster window 314b, a third Brewster window 314c, and a fourth Brewster window 314d), it should be appreciated that the set of Brewster windows 314a-314d may include more or fewer Brewster windows as may be desired.

The set of Brewster windows 314a-314d is positioned such that, when input light 310 is introduced into the input waveguide 206, at least a portion of the input light 310 passes through each of the Brewster windows. In this manner, the set of Brewster windows 314a-314d will generate a plurality of reflected beams (only a first reflected beam 313a and a second reflected beam 313b are depicted in FIG. 3) and passed beam 311. The passed beam 311 passes through each of the set of Brewster windows 314a-314d and is at least partially polarized with a first polarization (e.g., the TE mode), whereas each of the plurality of reflected light beams is reflected from a corresponding Brewster window of the set of Brewster windows 314a-314d and is at least partially polarized with the second polarization (e.g., the TM mode).

For example, each of the set of Brewster windows 314a-314d is positioned to intersect a corresponding portion of the slab waveguide 207 and to receive a corresponding portion of the input light 310. Each of the Brewster windows 314a-314d is angled relative to the corresponding portion of the input light at a corresponding angle that is the Brewster's angle for a corresponding target wavelength within the operating wavelength range. The input light 310 may be introduced into the slab waveguide 207 and directed (e.g., by the first set of reflectors) to the first Brewster window 314a. When the input light 210 is incident on the first Brewster window 314a, a portion of the input light 210 is reflected by the first Brewster window 314a to generate a first reflected beam 313a and a portion of the input light 310 is passed through first Brewster window 314a to generate a first portion 311a of the passed beam 311. The first portion 311a of the passed beam 311 is passed to the second Brewster window 314b, which reflects some of the light to generate a second reflected beam 313b and passes some of the light to generate a second portion 311b of the passed beam 311. Similarly, the third Brewster window 314c may receive the second portion 311b of the passed beam 311 and generate a third reflected beam (not shown) and a third portion 311c of the passed beam 311. The fourth Brewster window 314d may receive the third portion 311c of the passed beam 311 and generate a fourth reflected beam (not shown) and a fourth portion 311d of the passed beam 311. After the passed beam 311 has passed through each of the set of Brewster windows 314a-314d, the passed beam 311 may be directed to the first output waveguide 208a (e.g., by the second set of reflectors) as a first polarized output light 312a having a first polarization (e.g., the TE mode). As the passed beam 311 passes through the Brewster windows 314a-314d, each additional reflected beam removes more light of the second polarization from the passed beam 311, which further increases the degree of polarization of the first polarized output light 312a as compared to the input light 310.

One of the plurality of reflected beams may be directed to the second output waveguide 208b (e.g., by the third set of reflectors) as a second polarized output light 312b having a second polarization (e.g., the TM mode). In the variation shown in FIG. 3, the first reflected beam 313a may form the second polarized output light 312b. Because the input light 310 interacts with the first Brewster window 314a before the other Brewster windows 314b-314d, the first reflected beam 313a may have the highest intensity of the plurality of reflected beams. In some instances, such as when the first reflected beam 313a is expected to have an intensity that is higher than what is desired for a given polarization splitter 302, the polarization splitter 302 may be configured such that another reflected light beam (e.g., the second reflected beam 313b) is instead directed to the second output waveguide 208b to generate the second polarized output light 312b. To the extent that some of the reflected beams are not directed to an output waveguide, these reflected light beams may be directed to one or more light absorbing regions of the waveguide layer. For example, the polarization splitter 302 may include a set of light absorbing regions 350a-350b. The set of light absorbing regions 350a-350b (which may each be formed by doping a portion of the slab waveguide 207 or otherwise replacing a portion of the slab waveguide 207 with one or more materials that absorb light in the operating wavelength range) may be positioned such that the second, third, and fourth reflected beams are directed to and absorbed by the set of light absorbing regions 350a-350b.

It should be appreciated that while each of the set Brewster windows 314a-314d is angled at a corresponding angle that is the Brewster angle for a corresponding target wavelength of the operating wavelength range, different Brewster windows may be associated with different target wavelengths. For example, the first Brewster window 314a may be rotated relative to the input light 310 at a first angle that is the Brewster angle for a first target wavelength in the operating wavelength range, and the second Brewster window 314b may be rotated relative to the first portion 311a of the passed beam 311 (which represents a portion of the input light 310) at a second angle that is the Brewster angle for a different second target wavelength in the operating wavelength range. Accordingly, different target wavelengths may be selected to further balance performance of the polarization splitter 302 across the operating wavelength range. In other variations, each of the set of Brewster windows 314a-314d may be angled at a corresponding angle that is the Brewster angle for a common target wavelength. In these instances, all of the Brewster windows 314a-314d are rotated at the same angle relative to corresponding the portion of the input light 310 that is incident on each Brewster window.

When input light (or a portion thereof) passes through a Brewster window as described herein, the passed beam may be laterally shifted. For example, in the variation of the polarization splitter 202 shown in FIGS. 2A and 2B, the input light 210 may be traveling along a first direction (e.g., along the X axis shown in FIG. 2A) as it is incident on the input side 215a of the Brewster window 214. The passed beam 211 may, as it exits the output side 215b of the Brewster window 214, also travel in the first direction, but will also be laterally shifted in a second direction (e.g., along the Y axis shown in FIG. 2A) that is perpendicular to the first direction. The magnitude of this lateral displacement may be wavelength-dependent, and thus changing the wavelength of light present in the input light 210 may cause the passed beam 211 to be incident on different portions of the second curved reflector 232. This in turn may cause wavelength-dependent losses as the passed beam 211 is coupled into the first output waveguide 208a.

Returning to FIG. 3, in variations in which the set of Brewster windows includes a plurality of Brewster windows (such as the set of Brewster windows 314a-314d of polarization splitter 302), different Brewster windows may be angled in different directions relative to their corresponding portions of the input light 310. For example, the set of Brewster windows 314a-314d includes a first subset of Brewster windows (including the first Brewster window 314a and the third Brewster window 314c), where each of these Brewster windows is angled in a first rotational direction (e.g., counterclockwise) relative to a corresponding portion of the input light 310. The set of Brewster windows 314a-314d includes a second subset of Brewster windows (including the second Brewster window 314b and the fourth Brewster window 314d), where each of these Brewster windows is angled in a second rotational direction (e.g., clockwise) relative to a corresponding portion of the input light 310. In these instances, the first subset of Brewster windows will laterally shift portions of the passed beam 311 (e.g., the first portion 311a and the third portion 311c) in a first lateral direction, whereas the second subset of Brewster windows will laterally shift portions of the passed beam 311 (e.g., the second portion 311b and the fourth portion 311d) in a second lateral direction opposite the first lateral direction. The set of Brewster windows 314a-314d may be configured such that the passed beam 311, after passing through each of the set of Brewster windows 314a-314d, is aligned with (e.g., not laterally shifted relative to) the input light 310. In other words, the lateral shifts in the first lateral direction provided by the first subset of Brewster windows may be offset by the lateral shifts in the second lateral direction provided by the second subset of Brewster windows. This in turn may act to reduce the wavelength dependency of optical losses as the passed beam 311 is coupled into the first output waveguide 208a.

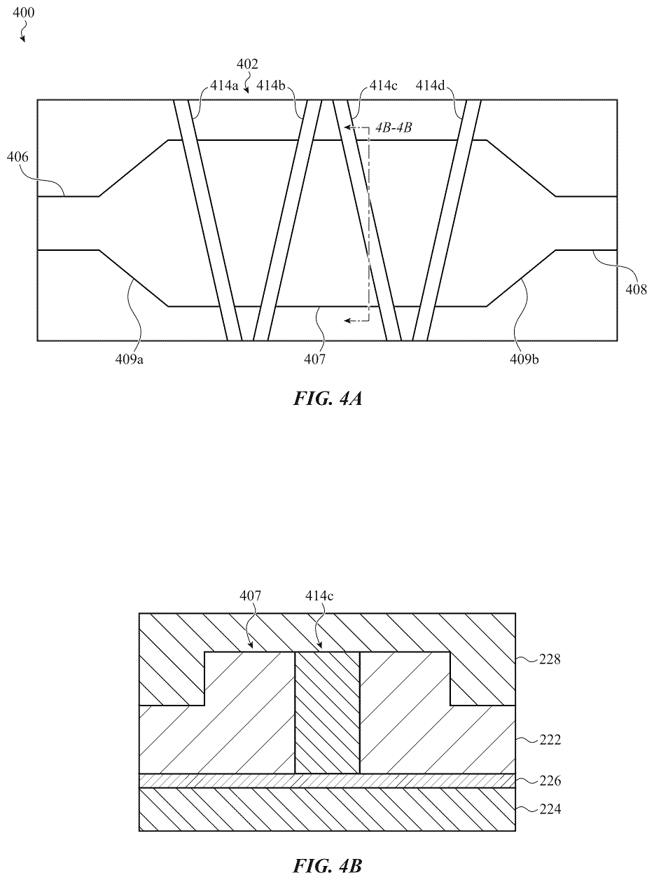

In other variations of the polarization splitters described herein, the polarization splitter may include an intermediate waveguide that is configured as a strip waveguide or a rib waveguide. For example, FIG. 4A shows a top view of a portion of a photonic integrated circuit 400 that includes a variation of polarization splitter 402 as described herein. FIG. 4B shows a cross-sectional side view of a portion of the photonic integrated circuit 400, taken along line 4B-4B. The photonic integrated circuit 400 may include a substrate 224, a first cladding layer 226 supported by the substrate 224, and a waveguide layer 222 supported by the first cladding layer 226, such as described herein with respect to the photonic integrated circuit 200 of FIGS. 2A and 2B. Similarly, in some instances the photonic integrated circuit 400 may include a second cladding layer 228 (not shown in FIG. 4A) positioned to cover one or more surfaces of the waveguide layer 222.

The polarization splitter 402 includes an input waveguide 406, an output waveguide 408, and an intermediate waveguide 407 optically connecting the input waveguide 406 to the output waveguide 408. Each of the input waveguide 406, and output waveguide 408, and the intermediate waveguide 407 may be defined in and formed from the waveguide layer 222. In the variation shown in FIGS. 4A and 4B, the intermediate waveguide 407 is configured as a rib waveguide. In other variations the intermediate waveguide 407 may be configured as a strip waveguide. As compared to the slab waveguide 207 of FIGS. 2A, 2B, and 3, the intermediate waveguide 407 may laterally confine input light received from the input waveguide 406 as it travels through the intermediate waveguide 407.

The polarization splitter 402 also includes a set of Brewster windows 414a-414d (such as described in more detail herein), each of which is positioned to intersect the intermediate waveguide 407 and to receive a corresponding portion of input light received by the input waveguide 406. Specifically, each of the set of Brewster windows 414a-414d is angled relative to the corresponding portion of the input light (and thereby relative to the intermediate waveguide 407) at a corresponding angle that is the Brewster's angle for a corresponding target wavelength within the operating wavelength range, such as described in more detail with respect to the Brewster windows 314a-314d of FIG. 3. In the variation of the polarization splitter 402 shown in FIG. 4, the output waveguide 408 is positioned to receive light that has passed through each of the set of Brewster windows 414a-414d. In these variations, the input waveguide 406 and the output waveguide 408 are positioned on opposite sides of the set of Brewster windows 414a-414d. Accordingly, when the input waveguide 406 receives input light, the output waveguide 408 may output polarized output light that is polarized with a TE mode.

In some variations, it may be desirable for a width of the intermediate waveguide 407 to be larger than the corresponding widths of the input waveguide 406 and the output waveguide 408. By increasing the width of the intermediate waveguide 407, the input light may more closely approximate a plane wave as it interacts with the set of Brewster windows 414a-414d. Accordingly, in some variations the polarization splitter 402 includes a first waveguide taper 409a connecting the input waveguide 406 to the intermediate waveguide 407 (e.g., to accommodate a difference in width between the input waveguide 406 and the intermediate waveguide 407) and a second waveguide taper 409b connecting the intermediate waveguide 407 to the output waveguide 408 (e.g., to accommodate a difference in width between the output waveguide 408 and the intermediate waveguide 407). In some variations the first and second waveguide tapers 409a-409b may be adiabatic so as not to unintentionally excite additional modes of light.

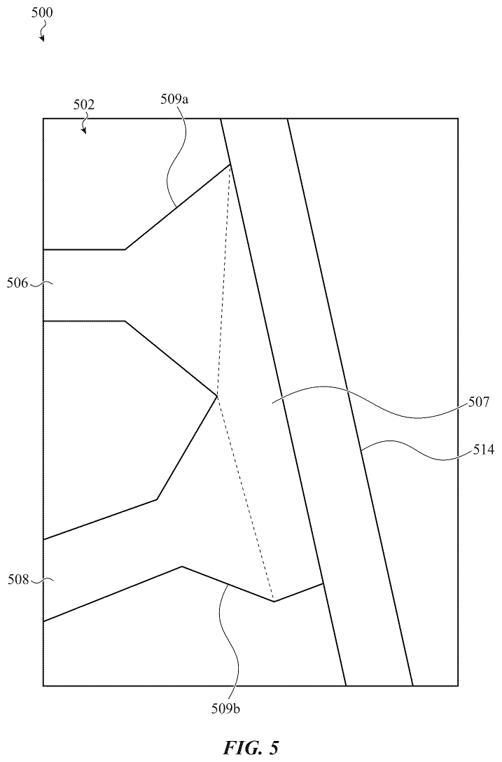

FIG. 5 shows a variation of photonic integrated circuit 500 that includes a polarization splitter 502 that is configured to generate polarized output light that is polarized with a TM mode. The polarization splitter 502 includes an input waveguide 506, an output waveguide 508, and an intermediate waveguide 507 optically connecting the input waveguide 506 to the output waveguide 508. Each of the input waveguide 506, and output waveguide 508, and the intermediate waveguide 507 may be defined in and formed from a waveguide layer (e.g., waveguide layer 222) of the photonic integrated circuit 500.

The polarization splitter 502 also includes a set of Brewster windows (shown in FIG. 5 as a single Brewster window 514), each of which is positioned to intersect the intermediate waveguide 507 and to receive a corresponding portion of input light received by the input waveguide 506. Each of the set of Brewster windows is angled relative to the corresponding portion of the input light (and thereby relative to the intermediate waveguide 507) at a corresponding angle that is the Brewster's angle for a corresponding target wavelength within the operating wavelength range, such as described in more detail with respect to the Brewster windows 314a-314d of FIG. 3. In the variation of the polarization splitter 502 shown in FIG. 5, the output waveguide 508 and the input waveguide 506 are positioned on a common side of the Brewster window 514, such that the output waveguide 508 is positioned to receive light that has been reflected from the Brewster window 514. Accordingly, when the input waveguide 506 receives input light, the output waveguide 508 may output a polarized output light that is polarized with a TM mode. In some variations, the polarization splitter 502 includes a first waveguide taper 509a connecting the input waveguide 506 to the intermediate waveguide 507 and a second waveguide taper 509b connecting the output waveguide 508 to the intermediate waveguide 507, such as described herein with respect to the waveguide tapers of FIGS. 4A and 4B.

In some variations, the polarization splitter 502 may include one or more light absorbing regions (not shown) positioned on an opposite side of the set of Brewster windows relative to the input waveguide 506, such that light that is passed through the set of Brewster windows is absorbed by the light absorbing region(s). In other variations, the polarization splitter 502 may include a second output waveguide (not shown) that is configured to output light that has passed through the set of Brewster windows.

It should be appreciated that the polarization splitters described herein may be designed to balance different performance parameters. For example, the angle(s) of the Brewster window(s) (e.g., the corresponding target wavelength for which a Brewster window is positioned at the Brewster's angle) may be selected to balance insertion losses against polarization extinction. Similarly, the size and relative spacing of the Brewster windows of a polarization splitter may be selected to reduce ripples in the resulting transmission spectrum. For example, in some variations, the spacing may vary between different Brewster windows of the plurality of Brewster windows 314a-314d of FIG. 3 (e.g., a first distance between the first Brewster window 314a and the second Brewster window 314b may be different than a second distance between the second Brewster window 314b and the third Brewster window 314c, and so on).

While the Brewster windows depicted in FIGS. 2A-5 are shown as having a rectangular shape (e.g., with a constant width), it should be appreciated that in some variations some or all of the Brewster windows of a polarization splitter described herein may have a wedged shape. In these variations, such a wedged Brewster window may have width that varies along the Brewster window, such that the input side of the Brewster window is angled relative to the output side of the Brewster window. This angular offset may be relatively small, such that the input side of a wedged Brewster window is positioned at the Brewster's angle for a first corresponding target wavelength within the operating wavelength range and the output side of the wedged Brewster window is positioned at the Brewster's angle for a second corresponding target wavelength within the operating wavelength range. For the purpose of discussion, the first corresponding target wavelength is considered the “target wavelength” for a wedged Brewster window. In these variations, introducing an angular offset between the input side and the output side of a Brewster window may reduce ripples in the transmission spectrum of the polarization splitter.

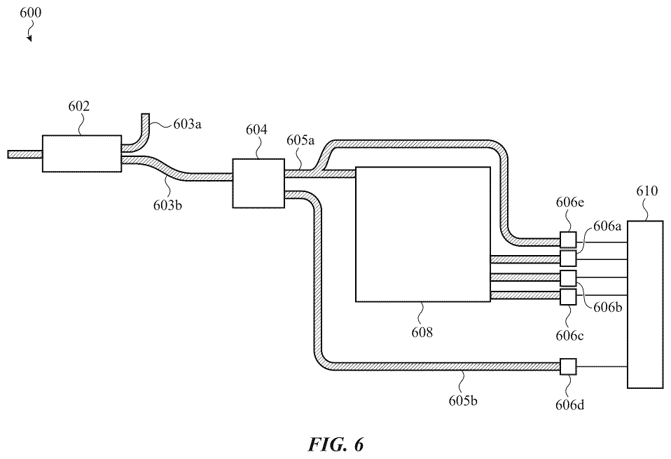

The polarization splitters described herein may be used for a variety of purposes within a photonic integrated circuit. For example, FIG. 6 shows a variation of a wavelength locking unit 600 that may be configured to control the operation of a light source (e.g., of light source unit 104 of the photonic integrated circuit 100 of FIG. 1). Specifically, the wavelength locking unit 600 may include a tap 602 that is configured to receive light generated by a light source. The tap may split the light between a first output 603a and a second output 603b. Light in the first output 603a may be directed to another portion of photonic integrated circuit that incorporates the wavelength locking unit 600, such that this light may be used by the photonic integrated circuit for other purposes. The second output 603b may be optically connected to a polarization splitter 604, such as those described herein. Accordingly, the second output 603b may form an input waveguide of the polarization splitter 604, and light received at the polarization splitter 604 from the second output 603b may be considered input light for the polarization splitter 604.

The polarization splitter 604 may include a set of output waveguides 605a-605b, each of which outputs a corresponding polarized light output. For example, the polarization splitter 604 is shown in FIG. 6 as including a first output waveguide 605a that outputs a polarized light output having a first polarization (e.g., a TE mode). At least some of this light may be measured by a set of detectors 606a-606d. For example, the wavelength locking unit 600 may include an interferometric component 608 that is configured to generate a set of wavelength-dependent interference signals. Specifically, the interferometric component 608 may include one or more Mach-Zehnder interferometers, multimode interference waveguides, or the like, which are configured to output one or more signals, where the intensity of each signal is dependent on the wavelength of the light received by the interferometric component 608. These signal(s) may be measured by a first subset of detectors 606a-606c and may be used by a controller 610 to provide feedback to the light source. Specifically, the controller 610 may use these signals to control the light source such that the light source outputs a target emission wavelength.

In some instances, the interferometric component 608 is designed to operate using light having the first polarization. Accordingly, the polarization splitter 604 may act to remove light of a second orthogonal polarization (e.g., a TM mode) from the input light before it reaches the interferometric component 608. This may improve the accuracy of the operation of the wavelength locking unit 600 as compared to similar wavelength locking units that do not include a polarization splitter. Additionally, in some instances it may be desirable to understand how well the polarization splitter 604 is performing during operation of the wavelength locking unit 600. For example, set of output waveguides 605a-605b may also a second output waveguide 605b that outputs a second polarized light output having the second orthogonal polarization. A portion of the second polarized light output may be measured by a corresponding detector 606d. Similarly a portion of the first polarization light output may be measured by a corresponding detector 606e. The signals from these detectors 606d-606e may reflect the relative polarization of the first and second polarized light outputs, which may provide an indication of how well the polarization splitter 604 is performing. Accordingly, in some instances, the controller 610 may uses these signals in controlling operation of the light source.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

What is claimed is:

1. A photonic integrated circuit, comprising:
a light source unit operable to generate input light at one or more wavelengths spanning an operating wavelength range; and
a polarization splitter comprising:
an input waveguide positioned to receive the input light;
a set of output waveguides;
an intermediate waveguide optically connecting the input waveguide to the set of output waveguides; and
a set of Brewster windows, wherein each Brewster window of the set of Brewster windows is positioned to intersect the intermediate waveguide and the polarization splitter is configured such that, when the input light is received at the input waveguide:
each Brewster window of the set of Brewster windows receives a corresponding portion of the input light;
each Brewster window of the set of Brewster windows is angled relative to the corresponding portion of the input light at a corresponding angle that is a Brewster angle for a corresponding target wavelength within the operating wavelength range; and
each output waveguide of the set of output waveguides outputs a corresponding polarized light output having a corresponding polarization.

2. The photonic integrated circuit of claim 1, wherein:
the set of Brewster windows is configured to generate, from the input light, a set of reflected beams and a passed beam;
each reflected beam of the set of reflected beams is reflected from a corresponding Brewster window; and
the passed beam passes through each Brewster window of the set of Brewster windows.

3. The photonic integrated circuit of claim 2 wherein:
the set of output waveguides comprises a first output waveguide;
the passed beam is directed to the first output waveguide to generate a first polarized light output having a first polarization as the corresponding polarized light output for the first output waveguide.

4. The photonic integrated circuit of claim 2, wherein:
the set of output waveguides comprises a second output waveguide; and
a first reflected beam of the set of reflected beams is directed to the second output waveguide to generate a second polarized light output having a second polarization as the corresponding polarized light output for the second output waveguide.

5. The photonic integrated circuit of claim 2, wherein:
the set of Brewster windows comprise a plurality of Brewster windows; and
the set of reflected beams comprises a plurality of reflected beams.

6. The photonic integrated circuit of claim 5, wherein:
the set of Brewster windows comprises a first subset of Brewster windows and second subset of Brewster windows;
each Brewster window of the first subset of Brewster windows is angled in a first rotational direction relative to the corresponding portion of the input light; and
each Brewster window of the second subset of Brewster windows is angled in an opposite second rotational direction relative to the corresponding portion of the input light.

7. A photonic integrated circuit, comprising:
a polarization splitter configured to receive input light at one or more wavelengths within an operating wavelength range, the polarization splitter comprising:
an input waveguide positioned to receive the input light;
a set of output waveguides;
a slab waveguide optically connecting the input waveguide to the set of output waveguides; and
a set of Brewster windows, wherein:
each Brewster window of the set of Brewster windows is positioned to intersect the slab waveguide;
the set of Brewster windows is configured to generate, from the input light, a set of reflected beams and a passed beam that passes through each Brewster window of the set of Brewster windows; and
each reflected beam of the set of reflected beams is reflected from a corresponding Brewster window.

8. The photonic integrated circuit of claim 7, wherein:
the polarization splitter comprises a first set of reflectors positioned in the slab waveguide and configured to collimate the input light.

9. The photonic integrated circuit of claim 7 or claim 8, wherein:
the set of output waveguides comprises a first output waveguide; and
the passed beam is directed to the first output waveguide to output a first polarized light output having a first polarization.

10. The photonic integrated circuit of claim 9, wherein:
the polarization splitter comprises a second set of reflectors positioned in the slab waveguide and configured to focus the passed beam on the first output waveguide.

11. The photonic integrated circuit of claim 7, wherein:
the set of output waveguides comprises a second output waveguide; and
a first reflected beam of the set of reflected beams is directed to the second output waveguide to output a second polarized light output having a second polarization.

12. The photonic integrated circuit of claim 11, wherein:
the polarization splitter comprises a third set of reflectors positioned in the slab waveguide and configured to focus the first reflected beam on the second output waveguide.

13. The photonic integrated circuit of claim 7, wherein:
the set of Brewster windows comprises a first subset of Brewster windows and second subset of Brewster windows;
each Brewster window of the first subset of Brewster windows is angled in a first rotational direction relative to a corresponding portion of the input light; and
each Brewster window of the second subset of Brewster windows is angled in an opposite second rotational direction relative to a corresponding portion of the input light.

14. A photonic integrated circuit, comprising:
a polarization splitter configured to receive input light at one or more wavelengths within an operating wavelength range, the polarization splitter comprising:
an input waveguide positioned to receive the input light;
an output waveguide;
an intermediate waveguide optically connecting the input waveguide to the output waveguide; and
a set of Brewster windows, wherein:
each Brewster window of the set of Brewster windows is positioned to intersect the intermediate waveguide at a corresponding angle that is a Brewster angle for a corresponding target wavelength within the operating wavelength range; and
the output waveguide outputs a polarized light output having a first polarization when the input waveguide receives the input light.

15. The photonic integrated circuit of claim 14, wherein:
the intermediate waveguide is a rib waveguide.

16. The photonic integrated circuit of claim 14, wherein;
the intermediate waveguide is a strip waveguide.

17. The photonic integrated circuit of claim 14, wherein:
the polarization splitter comprises a first waveguide taper connecting the input waveguide to the intermediate waveguide.

18. The photonic integrated circuit of claim 14, wherein:
the polarization splitter comprises a second waveguide taper connecting the intermediate waveguide to the output waveguide.

19. The photonic integrated circuit of claim 14, wherein:
the input waveguide and the output waveguide are positioned on a common side of the set of Brewster windows; and
the first polarization is a TM mode.

20. The photonic integrated circuit of claim 14, wherein:
the input waveguide and the output waveguide are positioned on a opposite sides of the set of Brewster windows; and
the first polarization is a TE mode.
